(19) United States
(12) Patent Application Publication
(10) Pub. No.: US 2008/0171153 A1
(43) Pub. Date: Jul. 17, 2008

(54) Container and cover system

(76) Inventors: Richard Scott Weston, Carlsbad, CA (US); Jasper Benke, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/654,926

(22) Filed: Jan. 17, 2007

(51) Int. Cl. B32B 1/02

(52) U.S. Cl. 427/458; 428/34.1

(57) ABSTRACT

An appliance is provided that may be used to hold fluids and other materials. The appliance generally comprises a container and a removable opaque flexible cover sheet that may be placed over the exterior side surface of the container to conceal the contents of the container from view. The cover sheet is removably attached to the container by electrostatic attraction. The cover sheet may be further comprised of indicia, such as logos, instructions, and scales for measurement, that are positioned thereon. The cover sheet may also be further comprised of detachable portions that may be removed from the remaining portion of the cover sheet. The appliance may also comprise a laminate liner sheet, to which the cover sheet is removably attached prior to being used to cover the container side surface. The present invention also includes methods for using various embodiments of the appliance.

### BACKGROUND

The present invention generally relates to containers that may be used to hold fluids and other materials, and more specifically to a container system that comprises a container and a removable cover that may be placed over the exterior side surface of the container to conceal the contents of the container from view.

In the biomedical field, it is common for health care providers to utilize containers (sometimes also referred to as canisters or reservoirs) as a part of patient treatment to collect and temporarily store exudate and other bodily fluids. Such treatments may include negative pressure wound therapy, blood transfusions, kidney dialysis, surgery, ivy and other medical treatments and procedures. The containers are typically constructed of glass or a plastic material and are often generally frusto-conical or cylindrical in shape. This type of construction is used because it makes the containers durable and easy to sterilize. The containers are also typically hermetically sealed with a lid, so that the contents are isolated from the surrounding environment. This prevents potentially harmful biological waste from being dispersed to the environment, where it may present a significant risk of harm to persons in the environs.

The exterior side surface of the containers is also typically constructed of a transparent material so that the health care provider may observe the contents of the container for purposes of monitoring patient treatment. For example, the health care provider may need to monitor the types of fluids (e.g., blood or fecal material) present in the container, as well as make periodic measurements of the volume of fluid or other material in the container. The transparent nature of the container allows the health care provider to perform these functions without the need to directly contact the fluids and materials in the container. When the contents of the container reach a predetermined level, or if the container is no longer needed as a part of the patient treatment, or for other reasons, the container may be removed. After termination of its use, the contents of the container are typically either emptied from the container, which may be reused after sterilization, or the container is disposed of along with its contents.

The transparent side surface of the containers, however, also presents certain disadvantages. For example, the exudate and fluid in the container may comprise pustular material, blood, urine, fecal matter, and other bodily fluids and biological waste materials. These fluids and materials usually have a very distasteful and unpleasant appearance. Thus, health care providers, patients and their visitors are often exposed to this unpleasantness, which can create feelings of awkwardness and embarrassment in those present. In addition, it is sometimes necessary for the health care provider to attend to the container during hours of darkness. The containers do not stand out in a dark room, so it may be difficult for the health care provider to locate them without turning on a light in the room. If the patient is sleeping, this can be a source of alarm and discomfort for the patient. Further, the containers are sometimes accidentally dropped or knocked from the platform where they are positioned. In these cases, the container may break, and sometimes shatter, releasing the contents of the container into the surrounding environment.

There is therefore a need for a container system that holds liquids and other materials produced during patient treatment, wherein the container system provides a means to cover the side surfaces of the container in a manner that allows the health care provider easy access to the container to observe fluid characteristics, while at the same time concealing the contents of the container from the view of others within visual distance of the container. This covering means must provide for a quick, easy and convenient way to cover and uncover the side surface of the container. In addition, the covering means should be flexible in the amount of the side surface that may be covered, so that it may cover much of the container, but leave a designation portion uncovered for visual access to the contents of the container by the health care provider. Further, it may be desirable for the covering means may have coloring or other characteristics that cause it to fluoresce in the darkness, so that the container can be easily located in a dark room. Further still, it is desirable that the covering means incorporate scales for measuring distance between two points, as well as the quantity of the contents of the container. Preferably, the covering means also allows the health care provider to record desired information on its surface, so that the information is retained in close proximity to the container when it is being used, but may then be removed from the container when the container is removed or discarded. In addition, it is desirable that the covering means provide an additional support for the side surfaces of the container, so that the container is more resistant to breakage, and if it does break, is more resistant to shattering, should the container be accidentally dropped.

### SUMMARY

The present invention is directed to an appliance and methods that satisfy the needs described above. As described in greater detail below, they have many advantages over existing containers and methods when used for their intended purpose, as well as novel features that result in a new appliance and methods that are not anticipated, rendered obvious, suggested, or even implied by any of the prior art apparatus or methods, either alone or in any combination thereof.

In accordance with the present invention, an appliance is provided for containing fluids and other materials. Generally, the appliance comprises a container and an opaque flexible cover sheet. The container further comprises an exterior side surface, wherein a substantial portion of the exterior side surface of the container is rigid or semi-rigid and has a smooth texture. The opaque flexible cover sheet has a size and shape adapted to be wrapped around and removably adhered to the substantial portion of the exterior side surface of the container. The opaque flexible cover sheet is removably held in place adjacent to the substantial portion of the exterior side surface of the container by electrostatic attraction between the surface of the cover sheet and the exterior side surface of the container when the cover sheet is wrapped around the substantial portion of the exterior side surface of the container. Preferably, the substantial portion of the exterior side surface of the container is comprised of at least 50% of the surface area of the exterior side surface of the container. In some embodiments, the opaque flexible cover sheet is comprised of a polymer material, such as vinyl. In other embodiments, the opaque flexible cover sheet further comprises indicia, which are positioned on the exterior surface of the opaque flexible cover sheet. The opaque flexible cover sheet may also have an edge bounding a surface thereof, so that the indicia are positioned approximately adjacent to the edge and are capable of measuring the quantity of fluids or other material held within the container. Alternatively, the indicia may be positioned approximately adjacent to the edge and be capable of measuring the distance between at least two points along the edge. The opaque flexible cover sheet may also be further comprised of a material that is fluorescent.

In still other embodiments, the appliance may further comprise a laminate liner sheet and liner attachment means to removably attach the opaque flexible cover sheet to the laminate liner sheet when the flexible cover sheet is not removably attached to the container. Preferably, the laminate liner sheet is comprised of a polymer material and the liner attachment means is a non-permanent adhesive. In yet other embodiments, the opaque flexible cover sheet may be shaped approximately as a rectangle when laid flat and the exterior side surface of the container may be approximately cylindrical in shape. In these embodiments, the flexible cover sheet is wrapped around and removably attached to the cylindrical exterior side surface of the container. In other embodiments, the exterior side surface of the container may be approximately frusto-conical in shape, and the opaque flexible cover sheet is of a size and shape adapted to be wrapped around and removably attached to the frusto-conical exterior side surface of the container.

In some embodiments, the opaque flexible cover sheet may be further comprised of a primary portion, at least one detachable portion, and detachable connecting means to detachably connect the primary portion to each at least one detachable portion, so that each at least one detachable portion may be detached from the primary portion. The connecting means may be comprised of a series of perforations separating the primary portion and the at least one detachable portion. In some of these embodiments, the primary portion and the at least one detachable portion may each be shaped approximately as a rectangle when laid flat, and the exterior side surface of the container may be approximately cylindrical in shape, so that the opaque flexible cover sheet is wrapped around and removably attached to the cylindrical exterior side surface of the container. In other of these embodiments, the container may be approximately frusto-conical in shape, and the opaque flexible cover sheet is of a size and shape adapted to be wrapped around and removably attached to the frusto-conical exterior side surface of the container. The opaque flexible cover sheet in these embodiments may also further comprise indicia, which are positioned on the exterior surface of the opaque flexible cover sheet.

The present invention also includes a method for placing a removable opaque flexible cover sheet on a container. The method comprises the action of wrapping the opaque flexible cover sheet around the container, wherein the opaque flexible cover sheet is removably held in place adjacent to the container by electrostatic attraction between the surface of the opaque flexible cover sheet and the exterior side surface of the container. The container and opaque flexible cover sheet may have substantially the same structure, features, characteristics and operation as containers and opaque flexible cover sheets described elsewhere herein. The method may also further comprise the action of removing the opaque flexible cover sheet from the container by lifting the opaque flexible cover sheet from the container. In embodiments where the opaque flexible cover sheet is further comprised of a primary portion, at least one detachable portion, and detachable connecting means to detachably connect the primary portion to each at least one detachable portion, the method may further comprise the action of removing the at least one detachable portion from the primary portion by disengaging the detachable connecting means.

As a result, the appliance of the present invention meets the needs described above in the Background section. The container system holds liquids and other materials produced during patient treatment. The appliance also provides a means to cover the side surfaces of the container in a manner that allows the health care provider easy access to the container to observe fluid characteristics, while at the same time concealing the contents of the container from the view of others within visual distance of the container. Thus, health care providers, patients and others are spared the embarrassment and awkwardness that may result from having the contents of the container available for ready viewing. The patient is allowed to retain his or her dignity. The burden on the health care provider in emptying the container is reduced. The health care provider and the patient both have the option of placing the cover sheet on the container when it is appropriate, and to not have the cover in place when it may be dangerous or otherwise disadvantageous to do so. The opaque flexible cover sheet also provides a quick, easy and convenient way to cover and uncover the side surface of the container. For example, the cover sheet is merely wrapped around the exterior side surface of the container and the electrostatic attraction between the cover sheet and the container holds the cover sheet in place without the need for adhesives or connectors. In addition, the opaque flexible cover sheet is flexible in the amount of the side surface of the container that may be covered. The cover sheet may cover much of the container, but leave a designated portion uncovered for visual access to the contents of the container by the health care provider. By detaching one or more of the detachable portions, the portion of the surface that is covered by the opaque flexible cover sheet may be reduced. Further, the opaque flexible cover sheet may have coloring or other characteristics or both that cause it to fluoresce in the darkness, so that the container can be easily located in a dark room. Further still, the opaque flexible cover sheet may incorporate scales for measuring the distance between two points or the quantity of the contents of the container or both. The distance measuring scale may be removed from the opaque flexible cover sheet by the health care provider, so that it can be used for treatment purposes, such as measuring the size of a wound. The opaque flexible cover sheet also allows the health care provider to record desired information on its surface, so that the information is retained in close proximity to the container when it is being used, but may then be removed from the container when the container is removed or discarded. Further, because the opaque flexible cover sheet is comprised of a flexible material whose entire surface is adhered to the exterior side surfaces of the container by electrostatic attraction, the cover sheet provides an additional support for the side surfaces of the container, so that the container is more resistant to breakage, and if it does break, is more resistant to shattering, should the container be accidentally dropped.

There has thus been outlined, rather broadly, the more primary features of the present invention. There are additional features that are also included in the various embodiments of the invention that are described hereinafter and that form the subject matter of the claims appended hereto. In this respect, it is to be understood that the invention is not limited in its application to the details of construction and to the arrangements of the components set forth in the following description or illustrated in the following drawings. This invention may be embodied in the form illustrated in the accompanying drawings, but the drawings are illustrative only and changes may be made in the specific construction illustrated and described within the scope of the appended claims. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

The foregoing summary, as well as the following detailed description of the preferred embodiments of the present invention, will be better understood when read in conjunction with the appended drawings, in which:

FIG. 1 is a perspective view of an embodiment of an appliance comprising the present invention;

FIG. 2 is a plan view of the opaque flexible cover sheet of the appliance of FIG. 1, as it would appear when lying on a flat surface;

FIG. 3 is a perspective view of another embodiment of an appliance comprising the present invention;

FIG. 4 is a plan view of the opaque flexible cover sheet of the appliance of FIG. 3, as it would appear when lying on a flat surface; and

FIG. 5 is an elevation view of the opaque flexible cover sheet of the appliance of FIG. 3 and FIG. 4, as it would appear when lying on a flat surface and positioned on a laminate liner sheet.

### DETAILED DESCRIPTION OF THE PREFERRED EMBODIMENTS

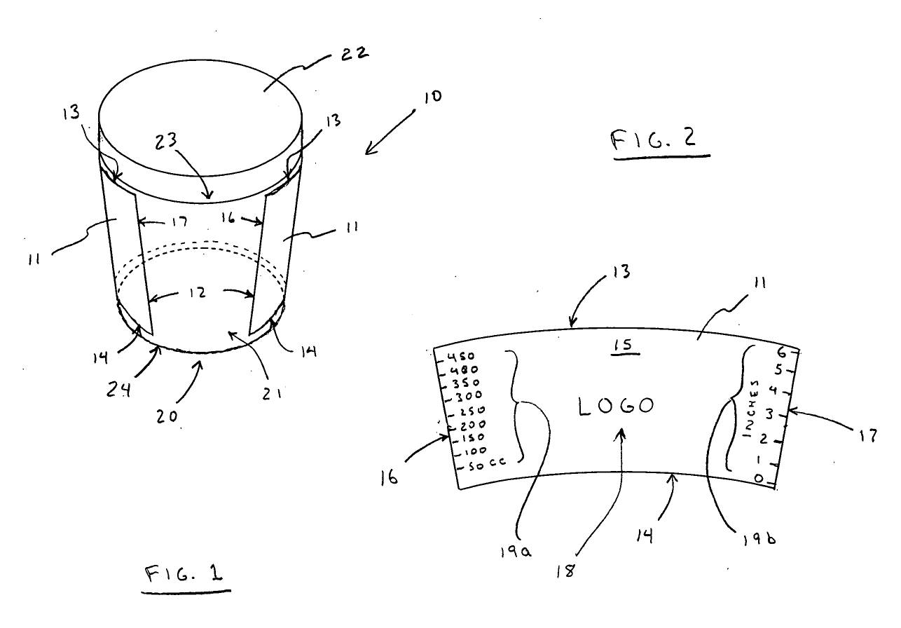

In accordance with the present invention, an embodiment of an appliance 10 is illustrated in FIG. 1, in which the appliance 10 is comprised of an opaque flexible cover sheet 11 and a container 20. In FIG. 1, the opaque flexible cover sheet 11 is illustrated in position on the container 20 while the cover sheet 11 is removably adhered to a rigid or semi-rigid smooth surface (in this case, a portion of the frusto-conical surface 21) of the container 20 by means of electrostatic attraction between the interior surface 12 of the cover sheet 11 facing the container 20 and the portion of the frusto-conical surface 21 of the container 20. The opaque flexible cover sheet 11 of FIG. 1 is illustrated in FIG. 2 as it would appear while lying on a flat surface and prior to being placed in position on the container 20. When the opaque flexible cover sheet 11 is covering the container 20, the appliance allows for the contents of the container to be hidden from view.

The opaque flexible cover sheet 11 is of a size and shape adapted to be wrapped around and removably adhered to a substantial portion of the exterior surface (frusto-conical surface 21 in this embodiment) of the container 20. For purposes related to this invention, the term “substantial portion” generally means a portion of the container 20 great enough so that the contents (not illustrated) of the container 20 may be hidden from view from the perspective of an observer viewing the container 20. For example, as illustrated in FIG. 1, the container 20 may have an opaque lid 22 that is placed over the top opening 23 of the container 20. In addition, the container 20 has a bottom surface 24 that is placed against a flat horizontal, and typically opaque, surface (not illustrated). Thus, when the opaque flexible cover sheet 11 is in position on the surface 21 of the frusto-conical portion (or side surface) of the container, the flexible cover sheet 11 covers approximately 80% of the surface 21 of the frusto-conical portion of the container 20. This combination of features allows the contents of the container 20 to be hidden from view from all directions except a relatively narrow viewing angle positioned above the portion of the container 20 that is not covered by the flexible cover sheet 11. The portion of the container 20 frusto-conical surface 21 that is not covered by the flexible cover sheet 11 may be left uncovered in order to allow an observer to access a scale imprinted or otherwise incorporated on or in the frusto-conical surface 21 that indicates the level of fluid or other material present in the container 20. In other embodiments, the flexible cover sheet 11 may cover more of, or all of, the frusto-conical surface 21 of the container 20. In still other embodiments, the flexible cover sheet 11 may cover less of the frusto-conical surface 21 of the container. For example, the flexible cover sheet 11 may extend only half way around or two thirds of the way around the frusto-conical surface 21 of the container 20. In addition, rather than being positioned relatively close to the top opening 23 of the container 20 and the bottom surface 24 of the container 20, as illustrated in FIG. 1, the top edge 13 of the flexible cover sheet 11 adjacent to the top opening 23 and the bottom edge 14 of the flexible cover sheet 11 adjacent to the bottom surface 24, respectively, may each be a greater distance from the top opening 23 or the bottom surface 24, respectively, than as illustrated in FIG. 1. This may be the case, for example, where an observer desires to be able to verify by visual observation that the fluid level in the container 20 is at least as high as the bottom edge 14 of the flexible cover sheet 11 or has exceeded the top edge 13 of the flexible cover sheet 11. Preferably, the substantial portion of the exterior side surface (frusto-conical surface 21) of the container 20 is comprised of at least 50% of the surface area of the exterior side surface 21 of the container 20. In addition, the substantial portion of the exterior side surface (frusto-conical surface 21) of the container 20 is preferably comprised of no more than 100% of the surface area of the exterior side surface 21 of the container 20.

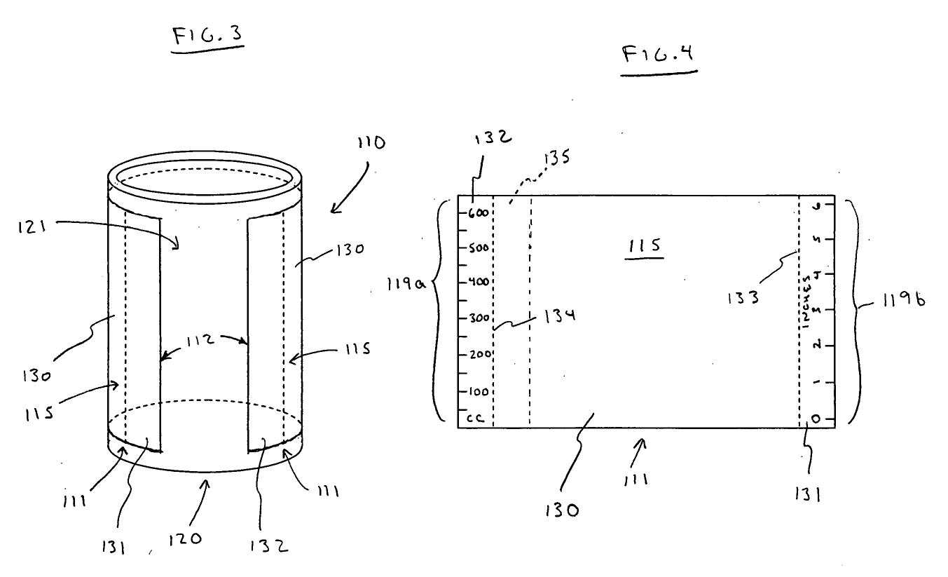

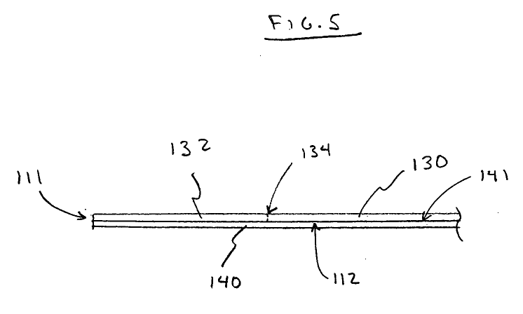

The same general principles with respect to covering a substantial portion of the container 20, as illustrated in FIG. 1, applies to other shapes of containers as well. For example, as illustrated in FIG. 3 and FIG. 4, the appliance 110 is comprised of an opaque flexible cover sheet 111 that is approximately rectangular in shape and is used to cover an approximately cylindrically shaped container 120. It is to be noted that there are many potential shapes of containers and flexible cover sheets that may be used in conjunction with one another to cover a substantial portion of the container in a manner that would effectively hide the contents of the container to the extent desired by the observer. For example, in the embodiment illustrated in FIG. 1, the container 20 may be covered by a flexible cover sheet 11 generally shaped as an ellipsoid, polygon, or a combination of such shapes. The preferred shape and size of the flexible cover sheet 11 and the substantial portion of the container 20 to be covered by the flexible cover sheet 11 is dependent upon a number of factors, such as the anticipated use of the container 20, the particular characteristics of the container 20 (e.g., size, shape, incorporated scales), the area of the substantial portion of the exterior side surface 21 to be covered, the contents of the container 20, and the preferences of the user of the appliance 10.

The flexible cover sheet 11 of FIG. 1 is generally opaque and may be comprised of any color, combination of colors, shades of colors, or any combination of the same. In addition, the flexible cover sheet 11 may be manufactured from a luminescent material so that the flexible cover sheet 11 may act as a location identifier to help the user locate the container 20, and to prevent the user of the container 20 from accidentally tipping, touching or moving the container 20, in a dark room. In addition, the flexible cover sheet 11 may have indicia positioned on the exterior surface 15 thereof that faces away from the container 20. As illustrated in FIG. 2, the indicia 18 may include advertising, marketing, promotional or other similar messages or a combination of such messages. (It is to be noted that the indicia 18, 19a, 19b of FIG. 2 are not illustrated on the exterior surface 15 of the flexible cover sheet 11 illustrated in FIG. 1.) The indicia on the flexible cover sheet 11 may also include graphics depicting animate and inanimate objects and other objects or combinations of such objects (not illustrated) in order to provide an aesthetically pleasing appearance. In addition, the indicia may include instructions or directions (not illustrated) regarding the use of the container 20 or its contents. Further, the indicia may include blank spaces (not illustrated) that may be completed with specified information regarding the contents of the container 20 or other matters. For example, the indicia may read “Time: ______ Quantity: ______” so that the user of the container 20 can record the indicated information directly on the appliance 10. Further still, the indicia may include scales, metrics or other means to measure quantities, distances and other parameters. For example, the vertical edge 16 of the flexible cover sheet 11 illustrated in FIG. 1 may have a scale 19a that may be used to measure the quantity of fluid or other material present in the container 20. As another example, the edge 17 of the flexible cover sheet 11 may have a scale 19b that may be used to measure distance. The indicia 18, 19a, 19b may be created using any appropriate means. For example, the indicia 18, 19a, 19b may be printed on the exterior surface 15 of the flexible cover sheet 11 using a suitable ink. This represents the preferred means of providing the indicia 18, 19a, 19b. Alternatively, the indicia 18, 19a, 19b may be positioned on the flexible cover sheet 11 using laser transfer, thermal transfer, color thermal transfer, impact transfer, inkjet transfer, digital offset, or electron beam transfer means or a combination of such means. As yet another alternative, the indicia 18, 19a, 19b may be comprised of another material that is attached to the exterior surface 15 of the flexible cover sheet 11. For example, indicia 18 that represent the logo for a company may be comprised of a thin layer of polymer material (not illustrated), such as vinyl, that is attached to the exterior surface 15 of the flexible cover sheet 11 by any suitable means, such as adhesive, adhesive tape, heat fusion, or any other suitable means or combination of such means. These types of indicia 18 may include what are commonly referred to as “decals” or “stickers”—an adhering layer having an adhesive present on one surface that permits the layer to be attached to the exterior surface 15 of the flexible cover sheet 11. Further still, the indicia 18, 19a, 19b may be fabricated as a part of the flexible cover sheet 11, where the indicia 18, 19a, 19b is comprised of material having a different color from the material comprising the remaining portion of the flexible cover sheet 11. The preferred indicia 18, 19a, 19b, as well as the means of providing it, are dependent upon a number of factors, such as the type of indicia 18, 19a, 19b desired, the anticipated use of the container 20, the particular characteristics of the container 20 (e.g., size, shape, incorporated scales), the area of the substantial portion of the exterior side surface 21 to be covered, the contents of the container 20, and the preferences of the user of the appliance 10.

It is to be noted that the substantial portion of the exterior surface (the frusto-conical portion 21) of the container 20 in FIG. 1 to which the flexible cover sheet 11 is removably adhered is generally rigid or semi-rigid and has a smooth texture. This rigidity and texture may typically be present in containers 20 constructed of materials producing a smooth, rigid or semi-rigid surface, such as glass, rigid polymers (such as acrylic or clear polycarbonate), or a combination of such materials, or such materials in combination with other materials, such as metal, wood or ceramic. Generally, any container commonly available for use in the applicable industry may be used as a part of the appliance 10, as long as it meets the requirements described herein to produce an electrostatic attraction between the container 20 and the opaque flexible cover sheet 11. The flexible cover sheet 11 may be constructed of any material that has sufficient tackiness to permit an electrostatic attraction between the flexible cover sheet 11 and the material comprising the portion of the container 20 to which the flexible cover sheet 11 is to be attached. For example, the flexible cover sheet 11 may be constructed of a static vinyl, nylon or polyurethane material that has a static capability and tackiness, or a combination of such materials, for use with containers 20 comprised of glass or rigid polymers, such as acrylic or clear polycarbonate. The preferred material in these cases is vinyl, such as that sold by FLEXcon Company, Inc. of Spencer, Mass., as FLEXmark V-400 series vinyl film. The preferred thickness of the flexible cover sheet 11 is in the range from 50 microns to 150 microns. The more preferred thickness of a flexible cover sheet 11 constructed of vinyl for use with containers 20 comprised of glass or rigid polymers involved in medical applications is 87.5 microns.

In still other embodiments, as illustrated in FIG. 3 and FIG. 4, the appliance 110 is comprised of a flexible cover sheet 111 having a size and shape adapted to be wrapped around and removably adhered to a substantial portion of the cylindrical exterior surface 121 of a container 120. The cylindrical exterior surface 121 of the container 120 is generally rigid or semi-rigid, has a smooth texture, and may have substantially the same characteristics, features and functions as the container 20 described above and illustrated in connection with FIG. 1. In the illustrated embodiment, the flexible cover sheet 111 is further comprised of a primary portion 130, two detachable portions 131, 132, and detachable connecting means (described in more detail below) to detachably connect the primary portion 130 to each of the detachable portions 131, 132. Although there are two detachable portions 131, 132 comprising the flexible cover sheet 111 in this embodiment, in other embodiments there may be only one detachable portion 131 or 132 or more than two detachable portions 131, 132. In other embodiments, the opaque flexible cover sheet 111 may also be comprised of multiply-detachable detachable portions 132, 135, such as would be the case if two detachable portions 132, 135 are positioned adjacent to one another. In such embodiments, one or more of the detachable portions 132, 135 may be removed from the primary portion 130, but they need not all be removed. For example, as illustrated in FIG. 4, either one detachable portion 132 or both detachable portions 132, 135 may be detached from the primary portion 130.

The detachable portions 131, 132 are preferably constructed of the same material, and have the same thickness as, the material comprising the primary portion 130. The detachable portions 131, 132 may, however, be constructed of a material different from the material comprising the primary portion 130, or may be of a different thickness from the thickness of the primary portion 130, or both. The flexible cover sheet 111, including its primary portion 130 and the detachable portions 131, 132, may each have substantially the same features, characteristics and functions as the flexible cover sheet 11 described above and illustrated in connection with FIG. 1 and FIG. 2. For example, the flexible cover sheet 111 may have different shapes, the flexible cover sheet 111 may be constructed from any of the materials that may be used to construct the flexible cover sheet 11, and the flexible cover sheet 111 may have indicia 119a, 199b present on the exterior surface 115 thereof. (It is to be noted that the indicia 119a, 199b are not illustrated on the exterior surface 115 of the flexible cover sheet 111 illustrated in FIG. 3.)

In the illustrated embodiment, the detachable connecting means is comprised of a series of perforations 133, 134 positioned along the boundary between the primary portion 130 and the detachable portions 131, 132, respectively. Although the detachable connecting means may be comprised of any suitable means in other embodiments, such as a line on the surface along which the material comprising the flexible cover sheet 111 may be cut using external means (such as scissors), the series of perforations 133, 134 are the preferred means. Thus, if desired by the user of the appliance 110, either or both of the detachable portions 131, 132 may be removed by tearing the detachable portions 131, 132 away from the primary portion 130 along the perforations 133, 134, respectively. By doing so, the user may position detachable portion 132 on a particular portion of the cylindrical surface 121 of the container 120 in order to measure the quantity of contents in the container 120 above a given level. For example, if the top level of the fluid in the container 120 is positioned one inch above the bottom surface 124, and the user desires to know the amount of fluid added to the container above this level, the user can detach the detachable portion 132 from the primary portion 130 and position the detachable portion 132 vertically oriented on the cylindrical surface 121 so that the zero level of the indicia 119a is at the same level as the fluid (one inch above the bottom surface 124). Similarly, the user of the appliance 110 can detach the detachable portion 131 from the primary portion 130 and use it as a ruler to measure distances, such as may be necessary to measure the dimensions of a wound.

In some embodiments, as illustrated in FIG. 5, and referring to the flexible cover sheet 111 of FIG. 3 and FIG. 4 as an example, the appliance 110 further comprises a laminate liner sheet 140 and liner attachment means (described in more detail below) to removably attach the flexible cover sheet 111 to the laminate liner sheet 140 when the flexible cover sheet 111 is not removably attached to the container 120. The laminate liner sheet 140 acts as a supportive backing for the flexible cover sheet 111 prior to its initial use in covering the container 120. In such embodiments, the flexible cover sheet 111, including its constituent primary portion 130 and detachable portions 131, 132, is removably held in position adjacent to the laminate liner sheet 140 by the liner attachment means, which may be comprised of electrostatic attraction or an adhesive positioned on the surface 141 of the laminate liner sheet 140 facing the flexible cover sheet 111. The preferred liner attachment means is a non-permanent adhesive positioned on the surface 141 of the laminate liner sheet 140 between the laminate liner sheet 140 and the flexible cover sheet 111. The laminate liner sheet 140 may be comprised of any suitable material, such as paper, polymer, cloth, fabric or a combination of such materials. The laminate liner sheet 140 is preferably constructed of a polymer or polymer-blend material. A laminate liner sheet 140 constructed of polymer is preferably in the range of 30 microns to 100 microns thick, and more preferably, is 38 microns thick. The more preferred flexible cover sheet 111 and laminate liner sheet 140 combination is similar to that sold by FLEXcon Company, Inc. of Spencer, Mass., as FLEXmark V-400 series vinyl film with a poly-flat release liner. When the user desires to utilize the flexible cover sheet 111 for purposes of covering the substantial portion of the container 120, he or she removes the flexible cover sheet 111 from the laminate liner sheet 140 by peeling the flexible cover sheet 111 away from the laminate liner sheet 140.

The present invention also includes a method of using the appliance 10, 110. Referring to the appliance 110 of FIG. 3 and FIG. 4 as an example, the method comprises the action of wrapping the flexible cover sheet 111 around the substantial portion of the exterior cylindrical surface 121 of the container 120, so that the opaque flexible cover sheet 111 is held in place against the container 120 by electrostatic attraction. The substantial portion of the exterior surface (the cylindrical surface 121) of the container 120 is rigid or semi-rigid and has a smooth texture. The flexible cover sheet 111 has a size and shape adapted to be wrapped around and removably adhered to the substantial portion of the exterior cylindrical surface 121 of the container 120. The flexible cover sheet 111 is removably held in place adjacent to the substantial portion of the exterior cylindrical surface 121 of the container 120 by electrostatic attraction between the surface of the flexible cover sheet 112 and the exterior cylindrical surface 121 of the container 120 when the flexible cover sheet 111 is wrapped around the substantial portion of the exterior cylindrical surface 121 of the container 120. In some embodiments, the method further comprises the action of removing one or both of the detachable portions 131, 132 from the primary portion 130 by disengaging the detachable connecting means, which comprises tearing the detachable portions 131, 132 from the primary portion 130 along the perforations 133, 134, respectively, in this embodiment. In other embodiments, the method further comprises the action of removing the flexible cover sheet 111 from the container 120 by lifting the flexible cover sheet 111 from the container 120. In yet other embodiments, the method further comprises the action of removing the flexible cover sheet 111 from the laminate liner sheet 140 by peeling the flexible cover sheet 111 away from the laminate liner sheet 140.

What is claimed is:

1. An appliance for containing fluids and other materials, the appliance comprising:
(a) a container further comprising an exterior side surface, wherein a substantial portion of the exterior side surface of the container is rigid or semi-rigid and has a smooth texture; and
(b) an opaque flexible cover sheet having a size and shape adapted to be wrapped around and removably adhered to the substantial portion of the exterior side surface of the container;
(c) wherein the opaque flexible cover sheet is removably held in place adjacent to the substantial portion of the exterior side surface of the container by electrostatic attraction between the surface of the opaque flexible cover sheet and the exterior side surface of the container when the opaque flexible cover sheet is wrapped around the substantial portion of the exterior side surface of the container.

2. The appliance of claim 1, wherein the substantial portion of the exterior side surface of the container is comprised of at least 50% of the surface area of the exterior side surface of the container.

3. The appliance of claim 1, wherein the opaque flexible cover sheet is comprised of a polymer material.

4. The appliance of claim 3, wherein the opaque flexible cover sheet is comprised of vinyl.

5. The appliance of claim 1, wherein the opaque flexible cover sheet further comprises indicia, which indicia are positioned on the exterior surface of the opaque flexible cover sheet.

6. The appliance of claim 5, wherein:
(a) the opaque flexible cover sheet has an edge bounding a surface of the opaque flexible cover sheet;
(b) the indicia are positioned approximately adjacent to the edge; and
(c) the indicia are capable of measuring the quantity of fluids or other material held within the container.

7. The appliance of claim 5, wherein:
(a) the opaque flexible cover sheet has an edge bounding a surface of the opaque flexible cover sheet;
(b) the indicia are positioned approximately adjacent to the edge; and
(c) the indicia are capable of measuring the distance between at least two points along the edge.

8. The appliance of claim 1, further comprising a laminate liner sheet and liner attachment means to removably attach the opaque flexible cover sheet to the laminate liner sheet when the flexible cover sheet is not removably attached to the container.

9. The appliance of claim 8, wherein the laminate liner sheet is comprised of a polymer material and the liner attachment means is a non-permanent adhesive positioned on the surface of the laminate liner sheet between the laminate liner sheet and the opaque flexible cover sheet.

10. The appliance of claim 1, wherein the opaque flexible cover sheet is shaped approximately as a rectangle when laid flat, the exterior side surface of the container is approximately cylindrical in shape, and the opaque flexible cover sheet is wrapped around and removably attached to the cylindrical exterior side surface of the container.

11. The appliance of claim 1, wherein the exterior side surface of the container is approximately frusto-conical in shape, and the opaque flexible cover sheet is of a size and shape adapted to be wrapped around and removably attached to the frusto-conical exterior side surface of the container.

12. The appliance of claim 1, wherein the opaque flexible cover sheet is further comprised of a material that is fluorescent.

13. An appliance for containing fluids and other materials, the appliance comprising:
(a) a container further comprising an exterior side surface, wherein a substantial portion of the exterior side surface of the container is rigid or semi-rigid and has a smooth texture; and
(b) an opaque flexible cover sheet having a size and shape adapted to be wrapped around and removably adhered to the substantial portion of the exterior side surface of the container, wherein the opaque flexible cover sheet is further comprised of a primary portion, at least one detachable portion, and detachable connecting means to detachably connect the primary portion to each at least one detachable portion, wherein each at least one detachable portion may be detached from the primary portion;
(c) wherein the opaque flexible cover sheet is removably held in place adjacent to the substantial portion of the exterior side surface of the container by electrostatic attraction between the surface of the opaque flexible cover sheet and the exterior side surface of the container when the opaque flexible cover sheet is wrapped around the substantial portion of the exterior side surface of the container.

14. The appliance of claim 13, wherein the substantial portion of the exterior side surface of the container is comprised of at least 50% of the surface area of the exterior side surface of the container.

15. The appliance of claim 13, wherein the opaque flexible cover sheet is comprised of vinyl.

16. The appliance of claim 13, wherein the detachable connecting means is comprised of a series of perforations separating the primary portion and the at least one detachable portion.

17. The appliance of claim 13, wherein the primary portion and the at least one detachable portion are each shaped approximately as a rectangle when laid flat, the exterior side surface of the container is approximately cylindrical in shape, and the opaque flexible cover sheet is wrapped around and removably attached to the cylindrical exterior side surface of the container.

18. The appliance of claim 13, wherein the container is approximately frusto-conical in shape, and the flexible cover sheet is of a size and shape adapted to be wrapped around and removably attached to the frusto-conical exterior side surface of the container.

19. The appliance of claim 13, wherein the opaque flexible cover sheet further comprises indicia, which indicia are positioned on the exterior surface of the opaque flexible cover sheet.

20. A method for placing a removable opaque flexible cover sheet on a container, the method comprising the action of wrapping the opaque flexible cover sheet around the container, wherein:
(a) the container further comprises an exterior side surface, wherein a substantial portion of the exterior side surface of the container is rigid or semi-rigid and has a smooth texture;
(b) the opaque flexible cover sheet has a size and shape adapted to be wrapped around and removably adhered to the substantial portion of the exterior side surface of the container; and
(c) the opaque flexible cover sheet is removably held in place adjacent to the substantial portion of the exterior side surface of the container by electrostatic attraction between the surface of the opaque flexible cover sheet and the exterior side surface of the container when the opaque flexible cover sheet is wrapped around the substantial portion of the exterior side surface of the container.

21. The method of claim 20, further comprising the action of removing the opaque flexible cover sheet from the container by lifting the opaque flexible cover sheet from the container.

22. The method of claim 20, wherein:
(a) the opaque flexible cover sheet is further comprised of a primary portion, at least one detachable portion, and detachable connecting means to detachably connect the primary portion to each at least one detachable portion, wherein each at least one detachable portion may be detached from the primary portion; and
(b) the method further comprises the action of removing the at least one detachable portion from the primary portion by disengaging the detachable connecting means.
